(19) United States
(12) Patent Application Publication
(10) Pub. No.: US 2025/0053984 A1
(43) Pub. Date: Feb. 13, 2025

(54) METHODS FOR USER PAYMENTS OR ACCESS VALIDATION MANAGEMENT THROUGH USER STATE DETERMINATION

(71) Applicant: Adeia Guides Inc., San Jose, CA (US)

(72) Inventors: Dhananjay Lal, Englewood, CO (US); Reda Harb, Tampa, FL (US); Jean-Yves Couleaud, Mission Viejo, CA (US)

(21) Appl. No.: 18/232,994

(22) Filed: Aug. 11, 2023

(51) Int. Cl. G06Q 20/40

(52) U.S. Cl. CPC G06Q 20/4016; G06Q 20/40145

(57) ABSTRACT

Systems and methods are described for enabling payment or access validation based on the state of a user. A user may initiate a transaction at a point-of-sale device by providing a biometric input. The user's affective state is determined based on the user's biometric input. If the probability that the user is under duress is above a threshold, a supplemental action is taken (e.g., denying the transaction, flagging the transaction for review, etc.).

### BACKGROUND

The present disclosure relates to methods and systems for enabling payment or access validation based on a user state. A user state may be determined based on the user's biometric data. In an embodiment, if the user is determined to be under duress based on the biometric data, supplemental actions may be taken. Some embodiments may relate to other features, functionalities, or fields.

### SUMMARY

Since the advent of contactless payment cards, smart payment technology at Point-of-Sale (PoS) devices has been evolving. Mobile payment systems such as Apple Pay® or Google Pay™ are widely used today. Newer technologies are also being deployed and tested, such as authenticating a user and transferring payment based on unique signatures in their palm or face. These techniques often do not require any additional device for payment, like a smartphone or smartwatch, and thus may be more convenient for some users. One example of such system is Amazon One™.

Similar to mobile payment systems, biometric-based identity solutions allow a user to associate a credit card or other payment mechanism with their palm scan, face scan, or other biometric input using a secure one-time enrolment process. Once registered, the user can simply scan their hand, face, or other biometrically relevant body part at a PoS device that accepts this form of payment authentication, and the user's associated credit card is charged. This technique allows the user to authorize payment via a stored credit card or other payment mechanism, without requiring the credit card or other payment mechanism to be physically present at the PoS device. This may provide improved security because, when using a part of the body as an identifier for payment, the risk of theft of the user's credit card or other payment mechanism is reduced.

However, there are several new problems that are created when using biometric based payment authorization or access validation. A first issue arises because the biometric input, such as a palm signature, is so intimately connected with the user that criminals may be incentivized to threaten a user (e.g., with violence or physical harm) to force him or her to make a payment or authorize access, rather than steal a phone, watch or wallet. That is, the criminal may attempt to physically force or intimidate in order to compel the user to purchase an item or withdraw money at a point-of-sale device using the user's biometric input (e.g., forcing the user to scan his or her hand to authorize a transaction). There exists a need to improve security of biometric-based identity PoS platforms.

With respect to criminals attempting to force a user to authorize a transaction, systems and methods of this disclosure address this issue and more by providing a payment application that can detect whether a user at a PoS device is under duress, and then take appropriate supplemental action with respect to any associated transaction. Supplemental actions may include declining the transaction, authorizing the transaction but flagging it for follow up or additional review, and/or requesting two-factor authentication or additional authorization by the user. Additionally, a supplemental action may include capturing images and/or audio from an area near the PoS device, in order to capture information about the possible source of duress (e.g., identifying information about the criminal attempting to force the user to authorize the transaction).

In some embodiments, the payment application may determine whether the user is under duress by analyzing biometric input to a user interface of the PoS device (e.g., a palm scan, face scan, etc.). For instance, a camera may capture a shaking hand and/or a face that appears anxious to, e.g., indicate a likelihood of duress. In some cases, a high temperature reading or excessive perspiration may indicate duress, e.g., from an infrared scan and/or skin contact measurement. In other embodiments, the payment application may receive secondary biometric data from a secondary device associated with the user, such as a smartwatch, smartphone, augmented reality device, or other wearable device configured to collect biometric data about the user. The PoS device, a server or other communicatively coupled computing device, and/or the secondary device itself may analyze the user's biometric data to determine a probability that the user is under duress. The payment application may then compare the determined probability of duress to a threshold, to determine whether to take an appropriate supplemental action. For example, if a user wears a smartwatch and the smartwatch detects a sudden large increase in heart rate immediately prior to the transaction, which may be indicative of the user's biological response to a threat from a criminal. The probability of duress in this case may be higher than in a case where, e.g., the user's heart rate remains constant.

In some embodiments, the payment application may also analyze a history of the user (e.g., a transaction history, location history, etc.), to inform its analysis of whether the user is under duress. For instance, the payment application may consider the user's history to determine whether the current transaction is abnormal for this user, whether the location of the current transaction is abnormal for this user, and/or whether any other aspect of the current transaction is abnormal for this user. The payment application may also consider a history of transactions at the current location for other users, to determine whether the current location has high number of thefts or other activity that make it more likely that a given user would be under duress.

Further issues with some approaches to smart payment technology include a lack of the ability to qualify the payment modality rather than simply having the system use one default credit card. For instance, the user may desire an ability to select a credit card from among her available credit cards and/or split a payment between multiple credit cards. Any system configured to carry out these actions must be enabled in a manner such that the convenience of using a biometric input such as a face or palm signature is not compromised.

Embodiments of this disclosure address this issue and more by providing a payment application that enables supplemental gestures to be received and analyzed with respect to a given transaction. For example, when authorizing a transaction, a user may make an additional gesture holding up a single finger, indicating that she wishes to have her first credit card used for this transaction. Alternatively, the user may hold up two fingers to select a second credit card. The user may also make first gesture to indicate that she wants to split the transaction between two or more credit cards, and then make further additional gestures to indicate over which credit cards the transaction should be split. The universe of possible gestures, combinations of gestures, and resulting actions taken by the payment application is large, and these examples are provided for illustration purposes only.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an example scenario in which a user's biometric data is used to determine whether to authorize a transaction, in accordance with some examples of the disclosure;

FIG. 2 is an example point-of-sale device for capturing a user's biometric data, in accordance with some examples of the disclosure;

FIG. 3 is a block diagram of an example system for emotion recognition using a wearable sensor, in accordance with some examples of the disclosure;

FIG. 4 is a simplified sequence diagram for enrolling a device into an identity management system, in accordance with some examples of the disclosure;

FIG. 5 is a simplified sequence diagram for passing biometric data between an external sensor and the identity management system, in accordance with some examples of the disclosure;

FIGS. 6A-C illustrate example systems which determine a probability that a user initiated a transaction under duress, and that the determination may be made by various devices in the system, in accordance with some examples of the disclosure;

FIG. 7 illustrates example gestures that may be interpreted to control payment options for a transaction, in accordance with some examples of the disclosure;

FIG. 8 illustrates an example method for interpreting gestures, in accordance with some examples of the disclosure; and

FIGS. 9-10 illustrate example devices, systems, servers, and related hardware for enabling payment and access validation based on a user's affective state, in accordance with some examples of the disclosure.

### DETAILED DESCRIPTION

Apple Pay was introduced in 2014, and Google Pay was introduced in 2018, replacing Google Wallet, which made its debut in 2011. These systems allow for contactless payment using near-field communication (NFC) technology, though their implementations are slightly different. For Google Pay, the user's card details are provided only once, during the initial setup. Google adopts an intermediary role and saves the card details on its servers. It then issues a virtual card to your device, the Google Pay Virtual Card. When paying, the device only transmits this virtual card information to the PoS device.

The vendor never has access to the real credit card information, which is protected by Google's secure servers. When the vendor charges the virtual card, Google, in turn, charges the stored debit or credit card and is the only entity that ever sees your real card through this transaction.

Apple employs a different system known as tokenization. Here, when the card details are provided to the device, the device contacts the issuing bank directly and upon confirmation receives a device-specific and card-specific token called the Device Account Number (DAN), which is stored on a secure chip on the device. The DAN structurally resembles a credit card number and is passed on to the merchant when any payment is made before getting authorized by the bank.

In other systems, palm or face-based payment technology may be used. In some examples, biometric information is not sent over a communication channel during the payment process, as this may create exposure to being intercepted. Instead, when biometric information is first scanned, the system converts the scan cryptographically into a hash or a code that cannot be reversed to recreate the user's palm print or facial scan. When the user pays, the PoS device or scanning machine does the same thing again. It scans the user's palm or face, creates a hash of the scan, and compares the hash to the one it has on file. If they match, the transaction is authorized. In this disclosure, examples may refer to the PoS device receiving a user's palm or face scan, or other biometric input. It should be appreciated that the PoS device may receive the user's biometric input via a suitable user interface. Examples herein that refer to the PoS device receiving the biometric input may also be interpreted as the PoS device receiving the biometric input via a suitable user interface of the PoS device or connected to the PoS device.

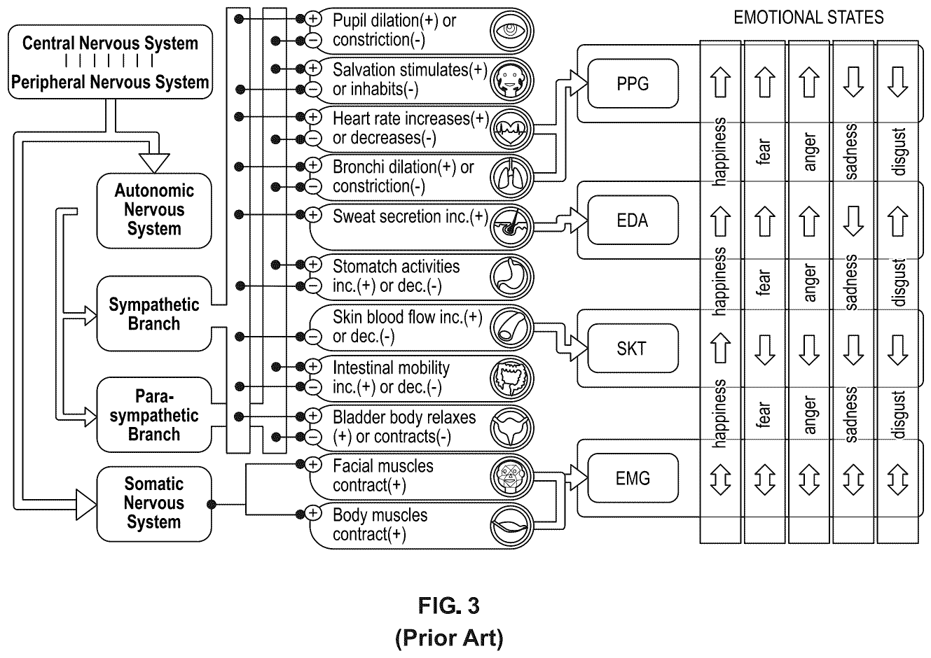

Examples of this disclosure leverage biometric data, biometric information, biomarkers, or physiological parameters of a user to validate that they are not under duress when making a payment (or gaining access to a secure property, safe, or other device). Each of these terms may be used interchangeably throughout the disclosure. Significant research and development in affective computing has been performed with the goal of detecting human emotion and/or affective state using wearable biosensors. In some examples, research on emotion recognition for wearables has focused mainly on using common biomedical sensors, and the collection of bio signals as a training dataset is fed to a classifier based on modern machine learning algorithms. Human emotion and/or affective state recognition accuracy varies according to the choice of sensor signals and their derivatives, the placement of sensors, the presentation and types of stimuli, as well as the different classification models and algorithms. FIG. 3 illustrates an example high-level simplified block diagram that may be used for human emotion detection.

In some examples, other research attempts to address detection of a specific emotion or state such as stress using physiological signals such as skin conductivity, which changes due to increased perspiration when a human is stressed. While blood cortisol tests, electroencephalography and physiological parameter methods may be the standards for measuring stress, they are typically invasive or inconvenient and not suitable for wearable real-time stress monitoring. Alternatively, cortisol in biofluids and volatile organic compounds (VOCs) emitted from the skin appear to be practical and useful markers for sensors to detect emotional stress events. Antistress hormones and cortisol metabolites have been identified as primary stress biomarkers that can be used in future sensors for wearable affective systems.

Detection of stress using facial images has also been studied. In some examples, image processing is used to detect emotional states in facial expression. However, emotion recognition using facial expressions remains a topic of debate. Emotions are expressed in a huge variety of ways, which makes it hard to reliably infer how someone feels from a simple set of facial movements.

In some examples, facial image processing is merged with electroencephalography (EEG) for improved emotional state detection, indicating that affective systems benefit from being multimodal. In some examples of this disclosure, emotion detection is performed by a PoS terminal system that may be geared to perform biometric analysis such as face identification, palm identification, etc., and may in addition may be multimodal such that two or more sources of information are used in the analysis.

Examples of this disclosure describe how a smart payment or access system may send additional parameters (e.g., user biometric inputs) that help validate the payment or the access request. Conversely, if a physiological parameter of the user attempting to pay or gain access is found to be abnormal or outside some threshold range, then the system may take supplemental action to request further validation, hold payment/access, or take some other action. This prevents miscreants from compelling a user to validate a payment using the user's biometric information under duress or pressure. Duress, in this context, may be understood to mean the user is acting under the threat of violence or is otherwise being coerced to act against their will or better judgment. Examples of this disclosure also describe methods by which a user may provide gestures at a payment terminal to execute a nuanced transaction such as allowing the user to choose one credit card for payment from among the multiple cards in their wallet, based on the particular gesture made by the user.

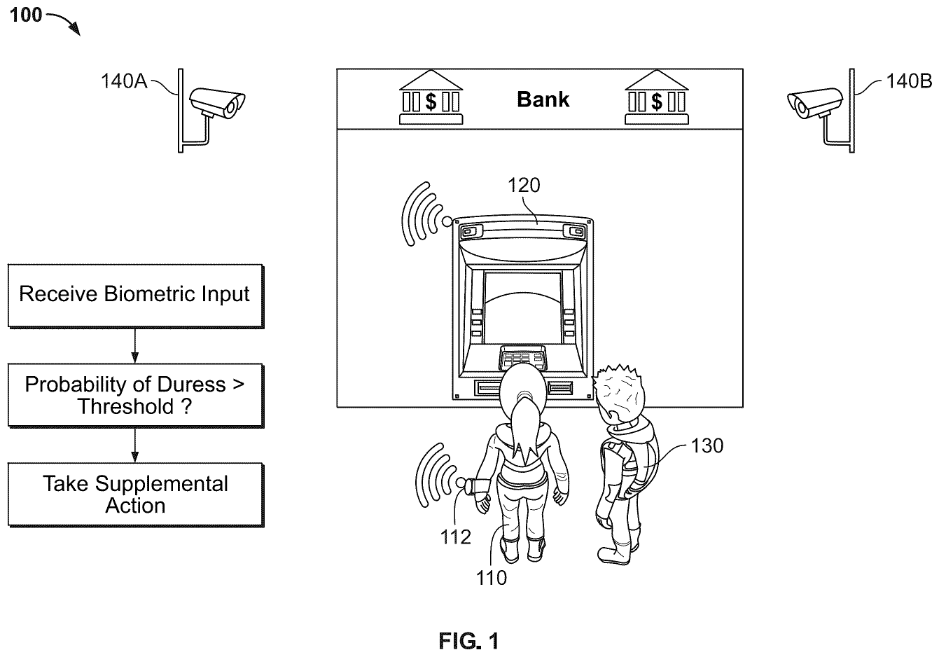

FIG. 1 illustrates a scenario 100 in which a user 110 attempts to interact with a PoS device 120 while the user 110 is under duress from a miscreant 130, in accordance with some embodiments of this disclosure. In the illustrated example, the user 110 is attempting to initiate a transaction by accessing her bank account via the ATM 120. The miscreant 130 approaches the user 110 and attempts to force her to withdraw money from the ATM 120. This is merely one example scenario in which the user 110 is under duress. It should be appreciated that many other scenarios may occur as well, such as a user accessing a bank, purchasing an item at a store or kiosk, and more.

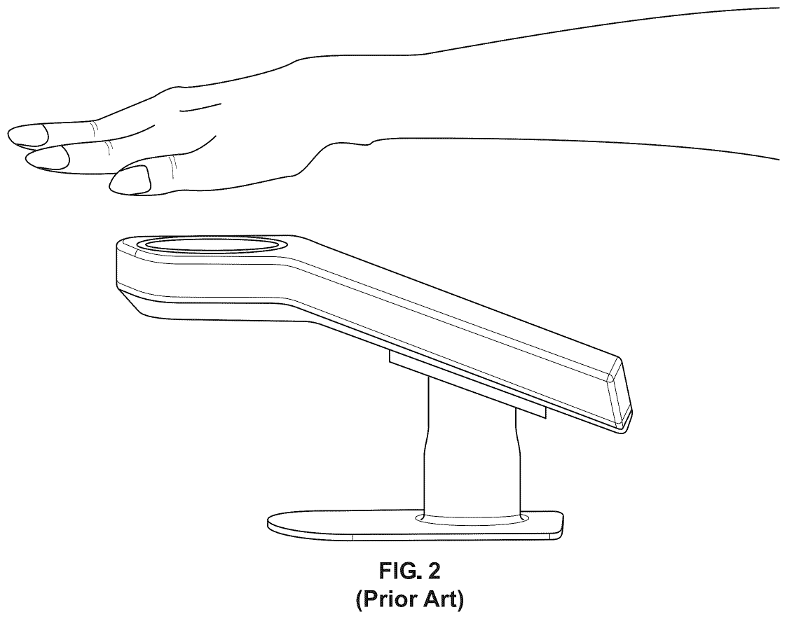

In scenario 100, the user 110 enters her biometric input to the PoS device (ATM 120) (via an appropriate user interface of the PoS device) in order to authenticate the user 110 with the PoS device. The PoS device 120 is illustrated in FIG. 1 as an automatic teller machine (ATM). FIG. 2 illustrates an example PoS device used for scanning a user's palm. It should be appreciated that in some examples, the PoS device may instead be an in-store PoS device, a Kiosk PoS device, a mobile PoS device, a counter-top PoS device, a tablet PoS device, card or chip scanner device, a touchscreen device, or any other suitable device or system configured to enable a person to initiate a transaction, access the person's private information, or otherwise interact with a vendor, merchant, bank, or other entity. Furthermore, the term “PoS” as used in the examples disclosed herein may also or alternatively be understood as any suitable “secured device” or “secure financial device.” That is, the examples, features, and functions described herein with respect to a PoS device should also be understood as applying to other devices and systems such as Automated Teller Machines (ATMs), safes, locks, alarm systems, and/or other devices or systems that require a user input to access some functionality. The examples included herein may use the term “PoS” as a non-limiting example to illustrate various aspects of the disclosure, and it should be appreciated that the same functions and features may also apply to other devices and systems.

As shown in FIG. 2, an example PoS device may include a palm reader or palm scanner. It should be appreciated that in other examples, biometric input may include other input types/sensors such as, for example hand or palm scanning, fingerprint scanning, face scanning, voice or audio scanning, heart rate measurement, skin temperature measurement, sweat level measurement, skin conductivity measurements, and more. Additionally, the biometric input may include a combination of two or more types as well.

Based on this biometric input, the PoS device 120 may determine a probability that the user 110 has initiated a transaction under duress or is acting under duress at the time the biometric input was made. In an example, the PoS device 120 may be communicatively coupled to an identity management back-end (e.g., a server), and the PoS device 120 may transmit the biometric input (or a representation thereof) to the server. The server may analyze the biometric input to determine a probability that the user is under duress, and/or a likelihood that the user to which the biometric input belongs was under duress at the time the biometric input was made. The server may compare the biometric input to known samples, or may use a machine learning model. In some examples, the user's biometric input may be converted to a hash or other format before being transmitted to the server. As described in further detail below, the server may store the hash of the user's biometric input, and may compare the stored hash to the newly received hash in order to authenticate the user, and/or to determine a probability that the user is under duress. Example techniques for determining the probability that the user is under duress may include analyzing the received biometric input using a machine learning model. In other examples, the received biometric input may be compared to known markers or other samples. Various other method for determining the probability that the user is under duress may be used as well.

In one example, a user's heart rate may be measured over time. If the user's heart rate increases to over 200 bpm, that may be an indication that the user is under duress. In another example, the user's skin temperature may be measured over time, and if the temperature is above 100 degrees that may be an indication that the user is under duress. In a further example, the user's arm movements may be measured, and if the user's arms shake or move in a certain manner (i.e., movement that indicates another person has grabbed and is pulling on the user's arm), that may be an indication that the user is under duress. In yet another example, the user's skin conductivity and/or sweat may be measured over time, and if the conductivity and/or sweat is above some threshold, that may indicate the user is under duress. It should also be appreciated that a combination of factors may be used as well. For instance, in one example both the user's heart rate and movement may be considered together, in order to differentiate between a user under duress and a user that is simply exercising. When the user's heart rate increases significantly, but the user is not moving a corresponding amount (e.g., the heart rate increase cannot be explained by the user exercising), that combination of information about the user may be used as a part of the determination that the user is under duress. Many other sources, types, and combinations of information about the user and the user's surroundings may be gathered and used in the determination of whether the user is under duress.

If the PoS device 120 and/or back-end server determines that the probability of duress is less than a threshold probability level, the user 110's transaction or access may be authorized in response. That is, if the PoS device determines that the user 110 is acting under normal circumstances (and is not under duress), the transaction is approved.

However, if the PoS device 120 and/or back-end server determines that the probability that the user initiated the transaction under duress is greater than or equal to the threshold probability level, the system may initiate a supplemental action with respect to the transaction. The supplemental action may include, for example, (a) denying the transaction or denying the user access, (b) flagging the transaction for additional review or analysis, (c) sending an alert to another device or system, (d) outputting an alert at the PoS device, (e) flagging the transaction or access attempt for additional review or analysis in addition to approving or denying the transaction or access attempt, (f) requesting further authorization from a secondary device (e.g., requesting two-factor authentication from the user's phone, smart watch, or other device), and then approving the transaction or enabling access in response to receiving authorization from the secondary device, and (g) capturing image data and/or audio data from one or more image sensors and audio sensors (e.g., cameras 140A and 140B) in proximity to the point-of-sale device after the biometric input was received.

Capturing additional image/sound data via one or more sensors proximate the PoS device can include using cameras or microphones to pick up video and audio of the area surrounding the PoS device. In some examples, the additional image/sound data may be captured by the user's device (e.g., smartphone). This captured video and audio may be reviewed later to identify the miscreant, or to determine whether the transaction was falsely flagged as being a user under duress, in the case where no miscreant is picked up by the video or audio.

In an example, the user may provide a biometric input directly at a biometric scanner of the PoS device. The PoS device may directly use a biometric scanner to determine the affective state of the user, and/or the probability that the user is under duress.

As noted above, the biometric input may be in the form of a palm scan input by a palm scanner. In other examples, a face detection scanner can be used to detect the user's expression. The face detection scanner may analyze the active patches or active regions of the face, and may determine the salient areas where the features are discriminative for different expressions. Using the appearance features from the salient patches, the system may perform a one-against-one classification task and determine the user's expression based on a majority vote.

Palm signature identification terminals (such as the device shown in FIG. 2) may also be able to collect some information on the user's physiological parameters. Image and infrared sensing may be used in identification for palm signatures. IR sensing may provide accurate imaging of the vein structure in the user's palm. IR sensors can also be used to measure skin temperature as a biomarker. IR temperature sensors enable accurate non-contact temperature measurement in medical applications. The most common applications for this type of temperature sensor are measuring ear temperature, forehead temperature, or skin temperature. Further, the palms of our hands (and soles of our feet) have more sweat glands than any other part of our body. After measuring of skin temperature using an IR camera, a thermodynamics computer model may be implemented to utilize these skin temperature values along with other environmental parameters, such as ambient temperature and relative humidity, to calculate the sweat rates of individual glands using chemically stimulated and unstimulated sweating.

With further advancement in non-contact sensing technologies, especially optical sensing technologies, the biometric scanners for identity/payment validation can also collect physiological information to determine the affective state of a user to ensure that an abnormal state is not observed. If the payment system has appropriate access, a user's internet browsing history, GPS history, email history, transaction history, and more may also be used to check their buying intent. For instance, by comparing data about a current transaction (e.g., current time, location, product, etc.) to historic data from the user, the PoS device and/or back-end server may determine whether the current transaction is out of place, fits within a pattern of expected user interactions, or is otherwise abnormal. While this analysis may help the system determine that an item being purchased correlates with the user's intent, without physiological data about the user, it may still be difficult to determine whether an item that does not have a corresponding correlation is being purchased under duress.

In some examples, a secondary device (i.e., separate from the PoS device) may provide biometric data and/or physiological information about the user that can be used to determine whether the user is under duress. The secondary device may include a smartphone, smart watch, heart rate monitor, augmented reality device (e.g., AR glasses), smart fabrics, biosensors, or other devices that collect biometric data about a user that can be used to determine the user's affective state. These secondary devices may also be referred to as “wearable devices” in this disclosure.

Secondary devices or wearable devices may need to be enrolled with the payment/identity management system and/or one or more other systems or devices in order to enable the biometric information they gather to be transmitted to the appropriate device(s) and be used to determine the user's affective state.

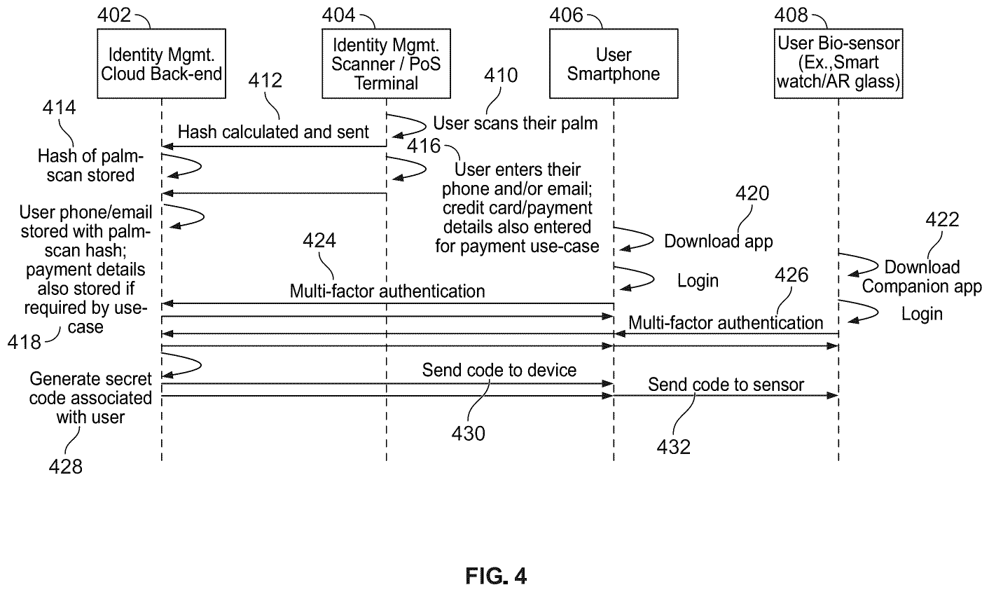

FIG. 4 illustrates an example process for enrolling a user's biometric data, as well as enrolling one or more secondary devices. In the illustrated example, the system includes an identity management backend 402, a PoS terminal 404, a user smartphone 406, and a secondary device 408. These devices enable a one-time enrollment process to enroll the user's biometric data (e.g., palm-scan) and associate it with the user's phone, email, or other identifying information, and (if required) credit card information or another identifier such as a merchant number.

The process of FIG. 4 also illustrates an enrollment process wherein the user may download an application on their mobile phone and/or secondary devices (e.g., standalone or companion apps for smartwatch, AR glasses etc.). The system performs multi-factor authentication to ensure that these devices are associated with the user using the user's phone number, email, or other identifying information. Some secondary devices 408, such as a Bluetooth-enabled smartwatch, may interact indirectly with the identity management cloud back-end 402 by using the mobile phone app on the smartphone 406 as a bridge. A secure cryptographic protocol such as HTTPS may be used for this operation of authenticating devices associated with the user. The user may create a login/password to register their devices, which are stored with the user's hash. The cloud back-end 402 may then generate a secret code associated with the user. This code is received by the user devices and used to verify the devices' association with the user when they are attempting to perform the physical operation of payment or access using their biometric input such as a palm signature or face scan. It should be understood that the process of enrolling secondary devices may be performed separately from the basic registration of the user's palm signature or other biometric input along with the user's phone number, email, or other identifying information.

As illustrated in FIG. 4, at step 410 the process begins by the user scanning her palm. It should be understood that a palm scan is only one example, and that any other type of biometric input may be used as well, such as a face scan, iris scan, or more. The biometric input is received at the PoS device or scanner 404.

At step 412, a hash of the user's biometric input is calculated and sent to the identity management back-end 402. A hash is used because it prevents the user's actual biometric information from being transmitted, and reduces the risk that the user's biometric information is intercepted by a third party. Additionally, the hash may be a smaller size, meaning that less bandwidth and resources are needed. At step 414, the hash is stored in the identity management back-end 402.

At step 416, the user enters her phone number, email, or other identification information. The user may also enter credit card information or other payment information. At step 418, this additional user information is transmitted to and stored by the identity management back-end 402 and associated with the hash of the user's biometric input. The information received at the PoS device and/or stored by the back-end 402 may depend on the particular use case or specifics of the system being operated. In some systems, only certain information may be stored, while in other systems there may be a variety of information stored.

At step 420, the user may download an application to their smartphone. The smartphone application may operate in connection with the back-end 402, the PoS terminal 404, and/or one or more secondary device(s) 408. The smartphone application may provide the user with information about their account, alerts when certain actions are taken, and/or receipts when a transaction is completed, among other things. As indicated above, the smartphone application may also act as a bridge or intermediary to enable the other devices (e.g., back-end 402, PoS terminal 404, and/or secondary devices 408) to communicate and transfer information.

At step 422, the user may download a companion application to their secondary device (e.g., an app on the user's smartwatch). This companion application enables data to be seamlessly transmitted to the smartphone 406, pos terminal 404, and/or back end 402 depending on the particular implementation. This companion application may also provide the user with information about their account, alerts when certain actions are taken, and/or receipts when a transaction is completed, among other things.

At steps 424 and 426, multi-factor authentication is performed for both the smartphone 406 and the secondary device 408. This may include the back-end 402 transmitting a request for authorization to the user's smartphone and/or secondary devices. The user may receive the request for authorization, and may approve, thereby completing the multi-factor authentication process. These steps may also include the use of one or more other systems or devices, such as one or more other servers, in order to communicate and/or complete the multi-factor authentication process.

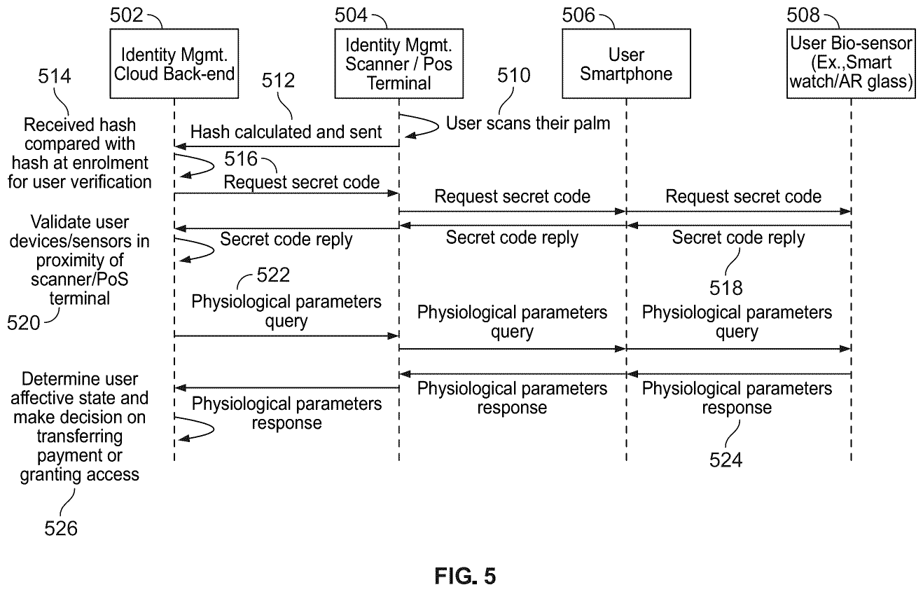

At step 428, the back-end 402 generates a secret code or unique identifier that is associated with the user. This secret code enables all the devices associated with the user, as well as the back-end 402 and PoS terminal 404 to ensure that they are authorized and associated with the correct biometric data and identifying information of the user. At steps 430 and 432, the secret code is transmitted to the smartphone and secondary device, to be stored for later use (as described in further detail with respect to FIG. 5). When the user attempts to initiate a transaction using their biometric information, the secret code can be used to ensure that the user is connected with the right information stored by the back-end 402.

Embodiments described in this disclosure may include both a smartphone and a secondary device (e.g., a smart watch or other device configured to capture a user's biometric information). However, it should be understood that in some examples, the smartphone itself may be interpreted as a secondary device on its own. That is, the smartphone may include one or more sensors or information sources that enable it to gather the user's biometric information, and/or various other information about the user that is used in the determinations described herein. That is, the smartphone may perform one or more functions described in this disclosure as being performed by a secondary device.

FIG. 5 illustrates a sequence diagram of a process associated with gathering and transmitting information between devices, according to some embodiments. The embodiment shown in FIG. 5 is a process of delivering the user's physiological parameters to the identity management system's cloud back-end 502, and for determining the user's affective state. The system shown in FIG. 5 includes the identity management back-end 502, the PoS terminal 504, the smartphone 506, and the user's secondary device(s) 508. In some examples, the identity management back-end 502 and the PoS terminal 504 may together be referred to as the PoS system. One or more functions described herein with respect to either the back-end 502 or the PoS terminal 504 may also be understood as being performed by a PoS system that comprises one or both of these. As such, some functions are described as being performed by the PoS terminal 504, but it should be appreciated that these functions may also be performed by the PoS system, and/or the back-end 502.

At step 510, the user scans their palm (or provides some other biometric input) to the PoS terminal 504. As noted above, the biometric input at step 510 may be a palm scan, face scan, iris scan, or any other suitable biometric input. At step 512, the biometric input is then hashed and transmitted to the back-end 502. After the PoS terminal transmits the palm-scan and/or hash to the back-end 502, at step 514 the back-end 502 verifies that the palm-scan (i.e., hash) matches with a stored version for the user.

At step 516, one the user's input is verified, the back-end 502 requests the secret code that was provided to the user devices and/or sensors, described above with respect to FIG. 4. The secret code is requested through the identity management scanner or the PoS terminal 504 to verify that the device(s) 508 are in close proximity of the user and the PoS terminal 504. A short-range wireless protocol such as Bluetooth, Wi-Fi, or 5G sideband may be used, as these may be commonly available on user devices. Wi-Fi Aware, specified by the Wi-Fi Alliance as a neighbor-aware networking protocol, builds service discovery into the operation of Wi-Fi so that higher layer (e.g., application layer) information can be exchanged using direct p2p communication between devices. The smartphone application and/or companion applications associated with physiological information collection operate as background processes on their respective devices.

The secret code request is received by the smartphone 506 and/or secondary device(s) 508, and at step 518 each device responds using the appropriate code that was provided during the enrollment process by the identity management system back-end 502. At step 520, the identity management system back-end 502 verifies a match of this secret code, and then at step 522 queries the device(s) 508 for the user's physiological information.

At step 524, the secondary device(s) of the user transmits the user's physiological information back to the back-end 502. As shown in FIG. 5, this physiological information may be transmitted using one or more intermediary devices acting as a bridge, such as the user's smartphone 506 and/or the PoS device 504. The back-end 502 may then use the user's physiological information to determine the user's affective state and/or the probability that the user is under duress at step 526.

In some examples, the back-end 502 may determine the user's affective state based on the user's palm scan (or other biometric input made to the PoS device). In other examples, the back-end 502 may determine the user's affective state based on the physiological parameters or biometric information gathered by the secondary device(s). In still other examples, the back-end 502 may determine the user's affective state based on a combination of both the initial biometric input to the PoS device, as well as the physiological parameters or biometric information gathered by the secondary device(s). As discussed below, the determination of the user's affective state may be performed by the back-end 502, by the PoS terminal 504, by the smartphone 506, and/or by the secondary device(s) 508. FIG. 5 is one example setup, and should not be understood as limiting the scope of this disclosure to only those embodiments in which the user's affective state is determined at the back-end device 502. Furthermore, the determination of the user's affective state and/or the probability that user is under duress can include consideration of the user's history (e.g., transaction history, location history, biometric information history, etc.) as well as other sources and types of information.

Referring back to FIG. 5, if the back-end 502 determines that the user's physiological parameters are abnormal, and/or that they indicate the user is experiencing fear/stress etc., then the system can take various supplemental actions in response, such as denying the user access or denying the transaction. Alternatively, the system may allow access or payment to proceed, while alerting another party that can perform a subsequent action to validate/invalidate that the user is under duress, similar to a “silent alarm” in home security systems. Additionally, in some examples, two-factor authentication can be used to directly query the user's registered devices before proceeding with payment or access. Other possible actions are descried above, and may include taking a picture using an associated camera such as a smartwatch or AR glasses camera (e.g., a secondary device associated with the user), recording voice samples, etc., to capture the signature of and later identify a potential miscreant. In some embodiments, a transaction can be flagged for review based on detection of the abnormal user state even if the transaction is not declined.

In some examples, the PoS terminal 504 may detect the presence of other individuals in proximity to the user, such as through imaging, Bluetooth beaconing, or using some other technique. The PoS 504 may also detect that the user is alone at the PoS and instruct the user to perform a gesture or action to inform they are under duress and alert authorities. In some embodiments, a message may be displayed at the PoS terminal informing the user that the transaction is declined due to possible duress detected through abnormal physiological parameters. This may reduce the possibility of harm to the user from a miscreant when the miscreant realizes that the system has exercised an option to decline the transaction or access, thereby rejecting the user's overtly expressed will that was a result of coercion. As it becomes more known that PoS devices will decline transactions for users under duress, would-be miscreants may be deterred from coercion.

In some examples, the secret code or identifiers that is used to authenticate the secondary device(s) may be changed after a certain time. For example, if a time period has expired, the next time the user attempts to initiate a payment or gain access, the system may issue the secondary device(s) a new code (after it has allowed the use of the previous code for the current session). This new code may then be requested by the back-end for authentication in the next session. In some embodiments, the system may issue the user devices new secret codes in every interaction session with the biometric scanner at the PoS terminal. In each case, the applications associated with the identity management system run the background on each device, so that the user does not lose the convenience that came with a simple palm or face scan for payment or access.

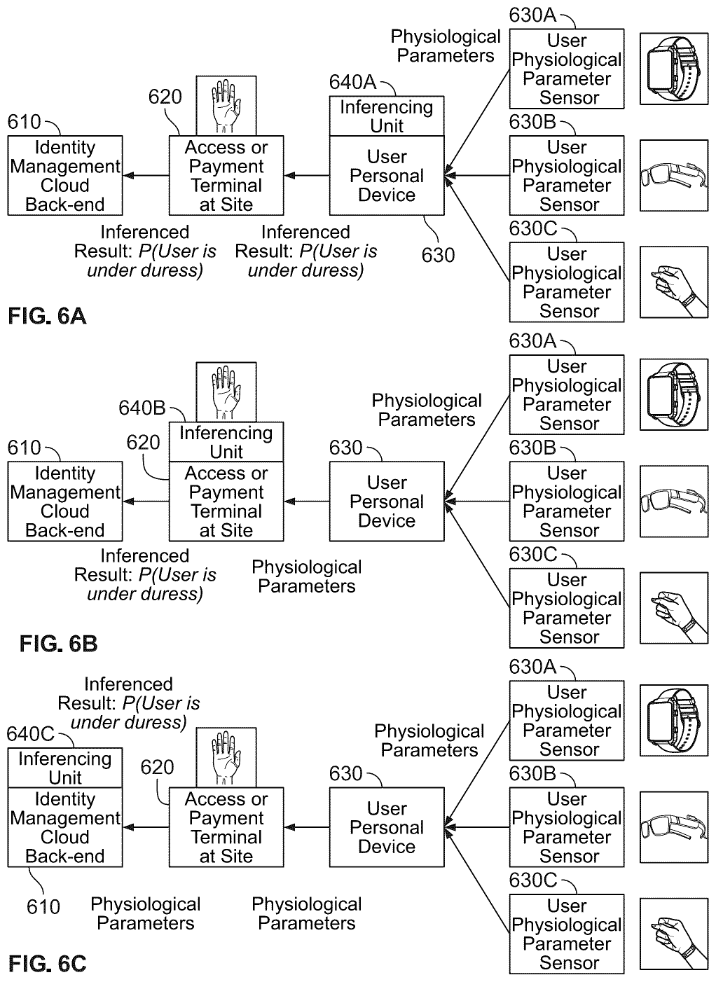

In some embodiments, rather than sending the user's physiological parameters to the identity management system back-end for inferencing (e.g., determining the user's affective state), an inference is performed locally on the PoS device or on the edge of the network. In this case, an inferencing unit, such as an embedded chip running a machine learning (ML) model (e.g., Google Edge TPU) may reside either in a user-side device, or in the biometric scanner/payment/access terminal. The inferenced result may indicate a probability of the user being under duress, which is then sent to the identity management back-end. Various examples are illustrated in FIG. 6. One determinant of where the inferencing unit is located may be where the system places its compute power needed for inferencing using either an algorithm or a machine learning model.

In some embodiments, the inferencing unit determines a sudden change in physiological parameters which indicates that the user may be under duress. The physiological parameters are requested after the palm scan has successfully authenticated the user identity, however authorization for the transaction or access may occur only after the physiological parameters are taken into account. In some embodiments, such as those where the inferencing unit is located at the user's smartphone, the inferencing unit periodically measures the user's physiological parameters. At the time the inferencing unit receives the request from the identity management system to determine whether the user is under duress, the inferencing unit may perform a lookup to determine whether an affective state change has occurred in the recent time (e.g., within a 2-5 min. time window prior to receiving the request from identity management system). In some embodiments, the affective state measurement can be triggered when the user is in proximity of the PoS terminal even if they have not provided their biometric input. That is, the inferencing unit may determine the user's affective state at regular intervals or in response to one or more triggers (e.g., entering a business, entering within a range of an ATM, etc.), even if the user has not begun initiating a transaction or attempt to gain access.

In some embodiments, in addition to physiological parameters, physical movements of the user may also be recorded to determine abnormalities, such as a sudden yank of a hand or other movement that is correlated with the user being under duress. The inferencing unit may distinguish abnormal physiological parameters due to high activity (e.g., exercise) from abnormal physiological parameters that occur due to duress (e.g., an affective state of fear, stress, or threat).

FIGS. 6A-C illustrate several example locations within the system where the inferencing unit that determines the user's affective state and/or the probability that the user initiates a transaction under duress may be located. The user's biometric data may be captured by the PoS device, by a secondary device (e.g., a smart watch), or via some other sensor or device. This data may be analyzed to determine the user's affective state (including but not limited to the probability that the user is operating under duress). This data may be analyzed by a single device of the system (e.g., at the PoS device, at the secondary device, or at the back-end device), or by multiple devices of the system. In some examples, the data may be partially analyzed by a first device, and partially analyzed by a second device. The determination of the user's affective state may also be made using raw data from the device(s) which collected the user biometric data, by using filtered data, or by using a combination of raw and filtered data. In some examples, two or more devices of the system may operate together to determine the user's affective state based on the user's biometric data and/or other user information.

FIG. 6A illustrates a first scenario, including an identity management cloud back-end device 610, a PoS device 620, and a user personal device 630 (e.g., a smartphone) that includes the inferencing unit 640A. Biometric information gathered by the PoS device 620 may be called biometric input, and may include a palm scan, face scan, or any other suitable biometric input. The user personal device 630 may be coupled to, for example, one or more secondary devices such as a smart watch (630A), an augmented reality device (630B), and/or some other wrist-based biometric sensor (630C). In the illustrated scenario of FIG. 6A, the secondary device(s) 630A-C gather biometric information about the user. This biometric information may be called “secondary biometric data” and may be passed to the user personal device 630, which includes an inferencing unit 640A. This secondary biometric data may be raw or may be filtered. Raw data may be simply the data that is collected by the secondary device itself. Filtered data may be raw data that has been analyzed (in whole or in part). The PoS device 620 may transmit the biometric input received at the PoS device to the user personal device 630. The inferencing unit 640A of the user personal device may then analyze the various sources of biometric data (and/or various other information associated with the user and/or PoS location), to determine the user's affective state. This may include determining a probability that the user is under duress, or has initiated a transaction while under duress. The user personal device 630 may then transmit the determination made by the inferencing unit 640A to one or more other devices or systems, such as the PoS device 620 and/or the back-end device 610, to be used in various decision making as described in this disclosure.

FIG. 6B illustrates a second scenario, including the identity management cloud back-end device 610, PoS device 620 that includes the inferencing unit 640B, the user personal device 630, and one or more secondary devices such as smart watch (630A), augmented reality device (630B), and/or wrist-based biometric sensor (630C). In the illustrated scenario of FIG. 6B, the secondary device(s) 630A-C gather the secondary biometric data about the user. The secondary biometric data may be passed to the user personal device 630 in either a raw state or a filtered state. Additionally, the PoS device 620 may receive the user's biometric input via any suitable input type, such as a palm scan or iris scan, for example. The user personal device 630 may transmit the secondary biometric data to the PoS device 620, which includes the inferencing unit 640B. The inferencing unit 640B of the PoS device 620 may then analyze the various sources of biometric data (and/or various other information associated with the user and/or PoS location), to determine the user's affective state. This may include determining a probability that the user is under duress, or has initiated a transaction while under duress. The PoS device 620 may then transmit the determination made by the inferencing unit 640B to one or more other devices or systems, such as the user personal device 630, and/or the back-end device 610, to be used in various decision making as described in this disclosure.

FIG. 6C illustrates a third scenario, including the identity management cloud back-end device 610 that includes the inferencing unit 640C, PoS device 620, the user personal device 630, and one or more secondary devices such as smart watch (630A), augmented reality device (630B), and/or wrist-based biometric sensor (630C). In the illustrated scenario of FIG. 6C, the secondary device(s) 630A-C gather secondary biometric data about the user. The secondary biometric data may be passed to the user personal device 630 in either a raw state or a filtered state. Additionally, the PoS device 620 may receive the user's biometric input via any suitable input type, such as a palm scan or iris scan, for example. The user personal device 630 may transmit the secondary biometric data to the PoS device 620 and/or the identity management cloud back-end device 610. The PoS device may also transmit the user's biometric input to the back-end device 610, which includes the inferencing unit 640C. The inferencing unit 640C of the back-end device 610 may then analyze the various sources of biometric data (and/or various other information associated with the user and/or PoS location), to determine the user's affective state. This may include determining a probability that the user is under duress, or has initiated a transaction while under duress. The back-end device 610 may then transmit the determination made by the inferencing unit 640C to one or more other devices or systems, such as the user personal device 630, and/or PoS device 620, to be used in various decision making as described in this disclosure.

The scenarios described above with reference to FIGS. 6A-C illustrate that the inferencing unit 640A-C may be located at a single location or may be part of a single device of the system. However, in some examples the inferencing unit may be distributed across two or more of the devices, or may be a part of a different device entirely. Additionally, the determination of the user's affective state, and/or the determination of the probability that the user is under duress, may be determined using two or more devices.

In some examples, one or more of the secondary devices 630A-C may capture biometric data. The secondary device(s) may then make an initial determination of the user's affective state, or an initial determination of the probability that the user is under duress. For example, the user's smartwatch may measure the user's heartrate and skin temperature, and based on this information may make an initial determination that the user is under duress. This initial determination may then be transmitted to the PoS device 620 (and/or the back-end device 610). The PoS device 620 (and/or the back-end device 610) may then make a secondary determination of the user's affective state or probability that the user is under duress, based at least in part on the initial determination, in addition to its own analysis of the secondary biometric data gathered by the secondary device(s), the initial biometric input provided to the PoS device, and/or various other information associated with the user and/or PoS location (e.g., transaction history, location history, etc.).

In some examples, the system (e.g., the inferencing unit or one or more of the devices of the system) may determine the user's affective state or probability that the user is under duress based on a change in biometric data. For instance, the heart rate of the user may be tracked over time, and when a threshold change in the user's heart rate is detected and aligns in time with the user initiating a transaction, the threshold change in heart rate may be an indication that the user was put under duress. The user's heart rate may be consistent over a period of several minutes, and then right as the transaction is about to occur, if the user's heart rate spikes that may indicate something negative has occurred, and the system may decide that supplemental action should be taken with respect to the transaction. In other examples, if the user's skin temperature, sweat, or other biometric measurement changes suddenly beyond a threshold, and/or the change aligns in time with the transaction (or is within a threshold time period before the transaction is initiated), that change may be an indication that the user is under duress, and this threshold change in biometric data may be used to determine the probability that the user is under duress.

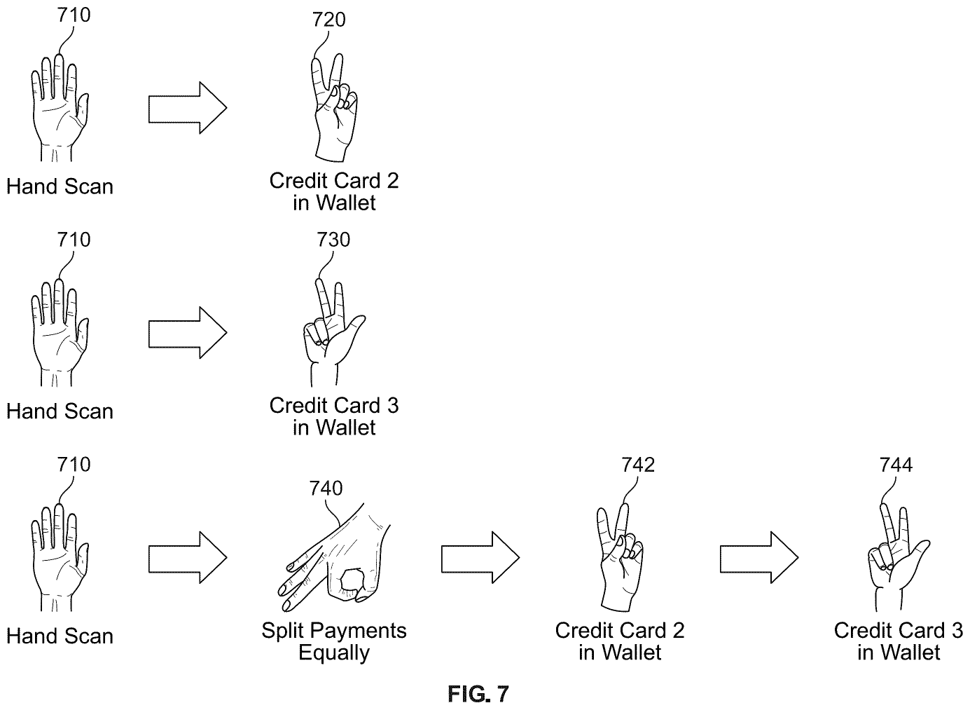

FIG. 7 illustrates several gesture input combinations that a user may make during a transaction, and the corresponding actions with respect to payment methods for the transaction that may be taken in response to receiving the gesture inputs. In some examples, a user may use the same hand (e.g., either the left hand or right hand) for both the initial scan as well as the additional gesture input(s). In other examples, the user may use a different hand for the initial scan and the additional gesture input(s). Furthermore, in some examples, a gesture input may include the use of both hands. The examples shown in FIG. 7 are for illustrative purposes only, and should not be understood as limiting the scope of the disclosure to only those illustrated gestures and hand combinations. Embodiments of this disclosure may enable a user to conduct a nuanced transaction (e.g., selecting one or more payment methods) while not sacrificing the convenience of “scan-and-go” for payments. In some examples, a user may have multiple credit cards, and the user may want to decide which card to use for payment on a per transaction bases at the PoS terminal itself. Rather than linking the user's palm signature to just one credit card or payment method, the user may provide multiple credit cards or payment methods at registration time. The user may also designate a default credit card. However, at registration time, the user may also provide one or more gestures that are to be associated with one or more specific credit cards, payment methods, or actions to be taken with respect to a transaction. These gestures may be scanned by the same PoS scanner (e.g., optical scanner, visible spectrum and/or IR imaging). During enrollment (discussed in further detail with respect to FIG. 4), when the user enters a gesture, they may be asked to designate a specific card, payment method, or action to be taken in response. The user can then use these gestures during checkout at a PoS for specifying the card to be used for payment, the payment method, or some other action.

FIG. 7 illustrates some example simple sign language gestures that may be interpreted at the PoS scanner, assisted by a semantic interpretation block, by registering gestures during the user enrollment process. In a first example shown in FIG. 7, the user inputs a hand scan 710 to the PoS device during a transaction. The user may then input a gesture 720 indicating the user's desire to complete the transaction by paying with “credit card 2” that is associated with the user. The user previously enrolled by entering the same gesture, and associating it with her second credit card.

In a second example shown in FIG. 7, the user inputs a hand scan 710 to the PoS device during a transaction. The user may then input a gesture 730 indicating the user's desire to complete the transaction by paying with “credit card 3” that is associated with the user. The user previously enrolled by entering the same gesture, and associating it with her third credit card.

In a third example shown in FIG. 7, the user inputs a hand scan 710 to the PoS device during a transaction. The user may then input a gesture 740 indicating the user's desire to split the transaction equally between two different credit cards. The user previously enrolled by entering the same gesture, and associating that gesture with an option to split payment equally between two credit cards. The PoS device, upon detecting the gesture 740, expects additional gestures to identify the credit cards among which the payment will be split. The user then inputs gestures 742 and 744 indicating the user's desire to complete the transaction using both “credit card 2” and “credit card 3” that are associated with the user.

It should be understood that these illustrated gestures are for example only. Many other possible gestures and associated actions and payment methods may be used as well or instead. Additionally, in some embodiments, the system may dictate certain gestures for specific purposes rather than giving the user the option of specifying gestures that they would like to use. That is, there may be predefined gestures associated with certain functions that the user cannot change (e.g., selecting credit card 2 using two raised fingers). In other embodiments, the system may only suggest certain gestures be used, while letting the user register gestures and their meaning. If device enrollment is permitted, then the system may also provide instant feedback after conducting a transaction (e.g., providing a push notification), or may confirm a transaction using the device user interface (e.g., smart watch or AR display) prior to proceeding with the payment.

If no gestures are received by the PoS scanner, then the default card or payment method may be used. In another embodiment, the default card that is charged or default payment method may be based on the identity or location of the PoS scanner. For example, a user whose virtual wallet includes more than one card, may prefer to use card 1 at Store A and card 2 at Store B. These preferences may be set by the user, during setup, and/or changed when the user desires. In some embodiments, the current card or payment method used for a given transaction may be automatically selected based on promotions between the host of the PoS scanner (i.e., the Store), and the credit card issuer (i.e., the bank). For example, a certain card may be chosen at Store C because of a promotion for 5% cashback on Card 3 when used at Store C, instead of the default card or payment method. These preferences may be set by the user.

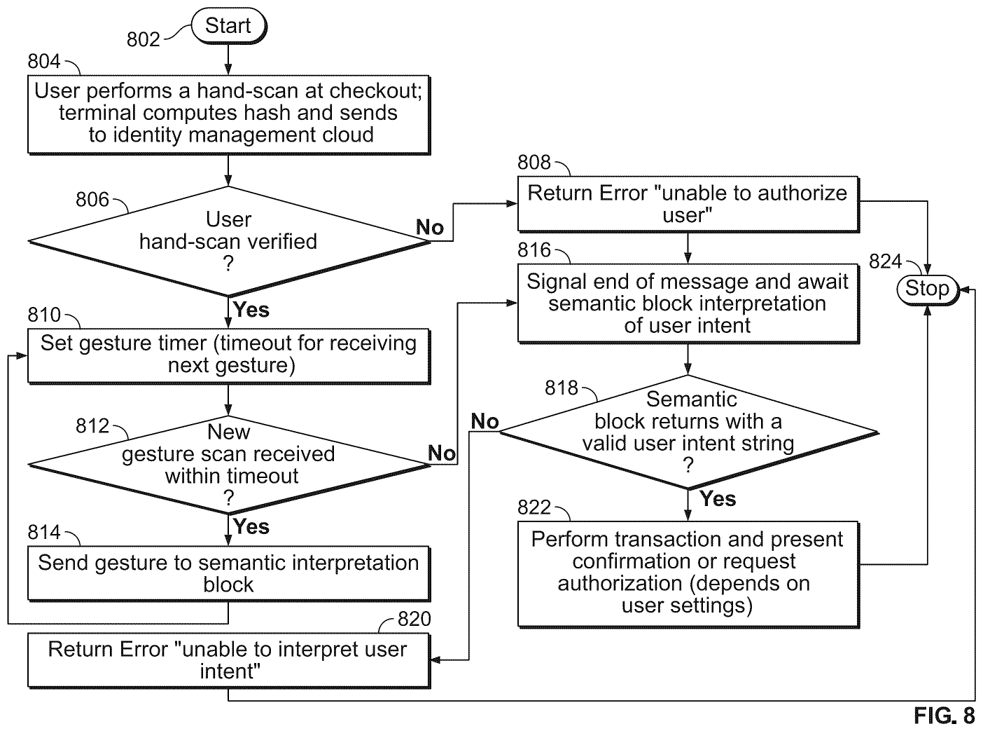

FIG. 8 illustrates a high-level flowchart for interpreting user intent from a series of gestures performed by the user in association with a transaction. In this example, the PoS scanner sets a timer allowing the user to enter one gesture after another. Each time a gesture is performed, the timer is reset. A series of gestures may contain an operation symbol as well as operands, as shown in FIG. 7. After no more gestures are received, resulting in timeout, the PoS scanner sends an “End of Message” indication to the semantic block responsible for determining the meaning of the series of gestures. The payment terminal is then able to forward this interpretation to the cloud back-end to execute the transaction. In some embodiments, the scanner caches the user's gestures, if any, as awaits the response from the cloud backend for user authentication.

The PoS scanner may treat a hand gesture differently from a user's palm scan. The hand gestures may be sent to the cloud backend, if the semantic block is located in the cloud, or it may be local if the semantic block is collocated with the scanner in the payment terminal. The hand gestures can be captured in much lower resolution than a palm scan (or other biometric input), since the system can tolerate a higher failure rate for the hand gestures than for user authorization. The scanning of the hand gestures may be in the visible imaging spectrum, in the IR spectrum, or using some other technique. The scanned gesture may be matched to a set of user or system stored gestures by the semantic block to convert it to an operation or operand. Although FIGS. 6A-C, 7, and 8 are shown for a use case in which the user's biometric input is a palm scan and the user provides additional hand gestures, the embodiments disclosed herein are not limited by these applications (as is true for the entire disclosure document). Palm scanning may be substituted by face scanning or some other biometric input method, and hand gesture scanning may be replaced by a combination of face and/or hand gestures, or other gesture or information input, for a payment terminal that uses face identification. In some examples, the PoS device may present icons or selectable buttons that enable the user to select a credit card, payment method, or action directly by interacting with the PoS device.

While the example shown in FIG. 8 refers to the use of a PoS device described herein, it will be appreciated that the illustrative process shown in FIG. 8, may be implemented, in whole or in part, on one or more other devices or systems, either alone or in combination with each other, and/or any other appropriately configured system architecture.

At step 802, the process begins. At step 804, the user inputs a biometric input (e.g., a hand or palm scan) to a PoS device, and the PoS device transmits the biometric input to a back-end device. This may be similar or identical to the processes described above with respect to FIGS. 4 and 5. At step 806, the back-end device determines whether the user is authenticated based on verifying the received biometric input (e.g., hand or palm scan). This authentication may include comparing the received hand scan or palm scan to a hand scan or palm scan received during enrollment of the user.

If the hand scan is not verified, then the process proceeds to step 808 wherein the back-end returns an error message. The PoS device may then indicate to the user that the hand scan or palm scan was not verified, and the process may stop at step 824.

If the user's biometric input is verified by the back-end, step 810 includes the PoS device setting a gesture timer. The gesture timer provides a time period during which the PoS device expects to receiver or is ready to receive a gesture from the user. At step 812, the PoS device determines whether it has received a new gesture scan within the time period identified by the gesture timer.

If a gesture is received at step 812, the PoS device sends the received gesture to a semantic interpretation block for interpretation. The method then proceeds back to step 810 to reset the gesture time and await further gesture inputs. Steps 810-814 repeat until there are no more gesture inputs.

When there are no more gesture inputs, and the gesture timer ends or reaches a timeout, the method proceeds to step 816. At step 816, the PoS device signals that the message is ended and awaits the interpretation of the gesture inputs. At step 818, the PoS device determines whether the semantic block has returned a valid user intent string based on the input gestures. If no valid string is returned, the method proceeds to step 820 wherein the PoS provides an error message to the user that their gestures could not be interpreted.

If the semantic block returns a valid string at step 818, the method proceeds to step 820. At step 820, the system performs the transaction according to the user's intent, as determined based on the input gestures. That is, if the user gestures indicated a desire to split the payment between two cards, the transaction is completed by splitting the payment between the appropriate cards. In some examples, the PoS device may also present an alert to the user or request further confirmation that the input gestures were properly interpreted. The PoS device may then receive confirmation, and may then carry out the transaction as desired by the user.

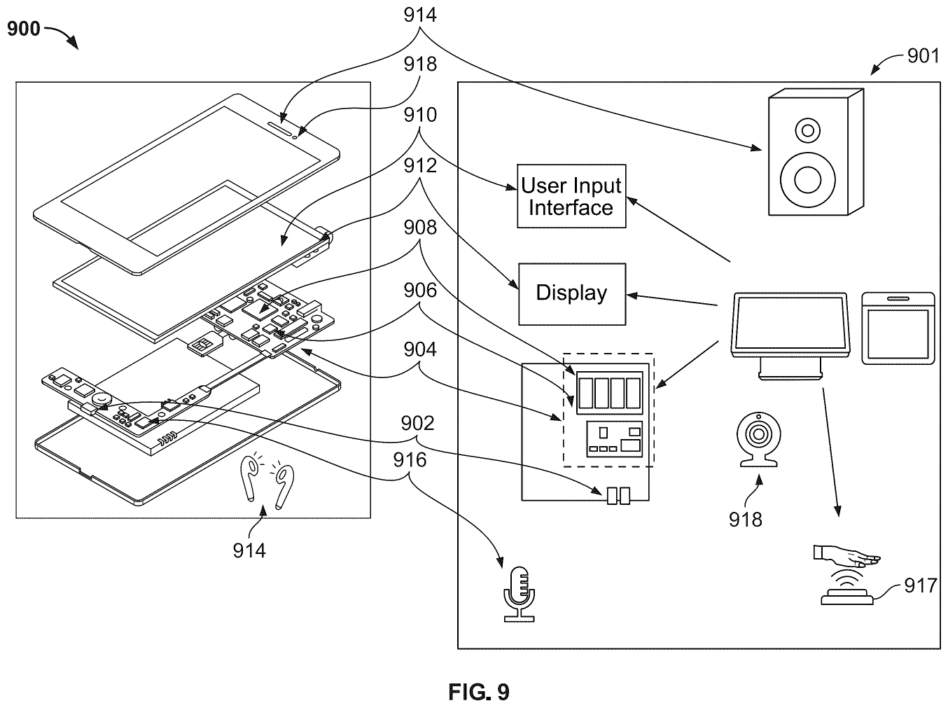

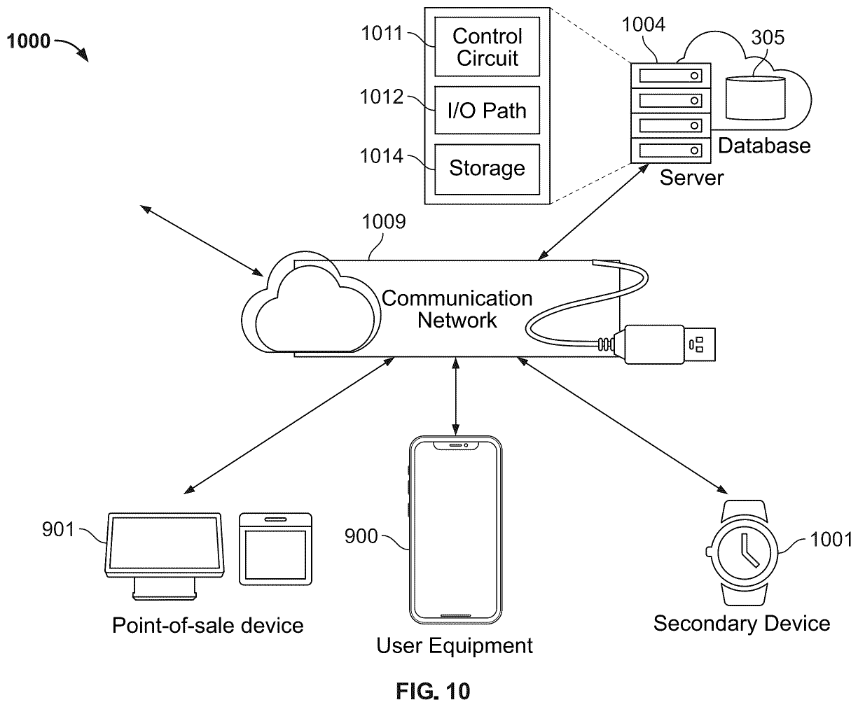

FIGS. 9-10 show illustrative devices, systems, servers, and related hardware for enabling payment or access validation based on a user state, in accordance with some embodiments of the present disclosure. FIG. 9 shows generalized embodiments of illustrative user equipment 900 and merchant point-of-sale device 901, which may correspond to, e.g., the smartphone 406, 506, and 630, and the PoS device 404, 504, and 620 described above. It will be understood that user equipment 900 may be referred to as a user device as described herein. In some embodiments, user equipment 900 may be a smartphone device, a tablet, a near-eye display device, a smartwatch, or any other suitable device capable of participating in a transaction, data transfer, or other media communication session (e.g., in real time or otherwise) over a communication network. Merchant point-of-sale device 901 may include or be communicatively connected to microphone 916, audio output equipment 914 (e.g., speaker or headphones), display 912, and one or more biometric input devices 917 (e.g., hand or palm scanner, face scanner, etc.). In some embodiments, display 912 may be a computer display, tablet display, smartphone display, or smartwatch display. In some embodiments, merchant point-of-sale device 901 may be communicatively connected to user input interface 910. In some embodiments, user input interface 910 may be a remote-control device. Merchant point-of-sale device 901 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment 900 and merchant point-of-sale device 901 are discussed below in connection with FIG. 10. In some embodiments, user equipment 900 may comprise any suitable number of sensors (e.g., gyroscope or gyrometer, accelerometer, NFC-based sensor, etc.), and/or a GPS module (e.g., in communication with one or more servers and/or cell towers and/or satellites) to ascertain a location of user equipment 900. In some embodiments, user equipment 900 comprises a rechargeable battery that is configured to provide power to the components of the device.

Each one of user equipment 900 and merchant point-of-sale device 901 may receive content and data via input/output path 902. I/O path 902 may provide content (e.g., content available over a personal area network (PAN), local area network (LAN), or wide area network (WAN) and/or other content) and data to control circuitry 904, which may comprise processing circuitry 906 and storage 908. Control circuitry 904 may be used to send and receive commands, requests, and other suitable data using I/O path 902, which may comprise I/O circuitry. I/O path 902 may connect control circuitry 904 (and specifically processing circuitry 906) to one or more communications paths (described below). I/O functions may be provided by one or more of these communications paths but are shown as a single path in FIG. 9 to avoid overcomplicating the drawing. While merchant point-of-sale device 901 is shown in FIG. 9 for illustration, any suitable computing device having processing circuitry, control circuitry, and storage may be used in accordance with the present disclosure. For example, merchant point-of-sale device 901 may be replaced by, or complemented by, a personal computer (e.g., a notebook, a laptop, a desktop), a smartphone (e.g., user equipment 900), a network-based server hosting a user-accessible client device, a non-user-owned device, any other suitable device, or any combination thereof.

Control circuitry 904 may be based on any suitable control circuitry such as processing circuitry 906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Server 1004 may be a part of a local area network with one or more of user equipment 900 and merchant point-of-sale device 901 or may be a part of a cloud computing environment accessed via the Internet. In a cloud computing environment, various types of computing services for performing the actions described in this disclosure are provided by a collection of network-accessible computing and storage resources (e.g., server 1004 and/or an edge computing device), referred to as “the cloud.” Merchant point-of-sale device 901 may be a cloud client that relies on the cloud computing capabilities from server 1004 to make various determinations about a user's affective state, as described herein. In some embodiments, user equipment 900 may be a cloud client that relies on the cloud computing capabilities from server 1004 to carry out the functions described in this disclosure.

Control circuitry 904 may include communications circuitry suitable for communicating with server 1004, edge computing systems and devices, a table or database server, or other networks or servers. The instructions for carrying out the above-mentioned functionality may be stored on a server (which is described in more detail in connection with FIG. 10). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of user devices, or communication of user devices in locations remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of data described herein (e.g., face scans, palm scans, hashes, secret codes, etc.). Nonvolatile memory may also be used (e.g., to launch a boot-up routine and other instructions). Cloud-based storage, described in relation to FIG. 9, may be used to supplement storage 908 or instead of storage 908.

Control circuitry 904 may receive instructions from a user by way of user input interface 910. User input interface 910 may be any suitable user interface, such as a remote control, mouse, trackball, keypad, keyboard, touch screen, touchpad, stylus input, joystick, voice recognition interface, or other user input interfaces. In some examples, the user input interface 910 is a gesture recognition module. Display 912 may be provided as a stand-alone device or integrated with other elements of each one of user equipment 900 and merchant point-of-sale device 901. For example, display 912 may be a touchscreen or touch-sensitive display. In such circumstances, user input interface 910 may be integrated with or combined with display 912. In some embodiments, user input interface 910 includes a remote-control device having one or more microphones, buttons, keypads, any other components configured to receive user input, or combinations thereof. For example, user input interface 910 may include a handheld remote-control device having an alphanumeric keypad and option buttons. In a further example, user input interface 910 may include a handheld remote-control device having a microphone and control circuitry configured to receive and identify voice commands and transmit information to merchant point-of-sale device 901.

Audio output equipment 914 may be integrated with or combined with display 912. Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 914 may be provided as integrated with other elements of each one of user equipment 900 and merchant point-of-sale device 901 or may be stand-alone units. An audio component of alerts and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 916 or audio output equipment 914 may include a microphone configured to receive audio input such as voice commands or speech. For example, a user may speak letters or words that are received by the microphone and converted to text by control circuitry 904. In a further example, a user may voice commands that are received by a microphone and recognized by control circuitry 904. In some instances, a voice command may be used to facilitate an authentication process related to payments involving the described virtual cards (e.g., a user might be prevented from making a payment if he fails an authentication process). Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 918 may be an analog camera that converts to digital images via a video card. In some instances, the camera 918 may be used to capture an image of the user (e.g., of the user's face or hands when inputting a gesture). The captured image may be used to facilitate an authentication process or selection of a payment method as described above.

Instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, animation data, notification sound data, card image data, contextual data, processing data, and payment card transaction data from user equipment 900—including a virtual payment card. Control circuitry 904 may obtain all or part of other user profiles that are related to a particular user (e.g., via contextual data, including connected device data and/or proximity data to known devices), and/or obtain information about the user from other sources that control circuitry 904 may access. As a result, a user can be provided with a unified experience across the user's different devices.

FIG. 10 is a diagram of an illustrative system 1000 for enabling payment or access validation based on a user's affective state, in accordance with some embodiments of this disclosure. User equipment 900, secondary device(s) 1001, merchant point-of-sale device 901, and server 1010 (e.g., a back-end server) may be coupled to communication network 1009. Communication network 1009 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1009) may separately or collectively include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 10 to avoid overcomplicating the drawing.

Although communications paths are not drawn between user equipment 900 and merchant point-of-sale device 901, these devices may communicate directly with each other via communications paths as well as other short-range, point-to-point communications paths, such as USB cables, IEEE 1394 cables, wireless paths (e.g., Bluetooth, infrared, IEEE 702-11x, near-field communication (NFC), etc.), or other short-range communication via wired or wireless paths. User equipment 900 and merchant point-of-sale device 901 may also communicate with each other directly through an indirect path via communication network 1009.

System 1000 may comprise one or more servers 1004, and/or one or more edge computing devices. In some embodiments, the server 1004 may be configured to host or otherwise facilitate transactions and/or data transfer between user equipment 900, merchant point-of-sale device 901, and secondary device 1001 and/or any other suitable user devices, and/or host or otherwise be in communication (e.g., over network 1009) with one or more other devices or systems.

In some embodiments, server 1004 may include control circuitry 1011 and storage 1014 (e.g., RAM, ROM, Hard Disk, Removable Disk, etc.). Storage 1014 may store one or more databases. In some embodiments, storage 1014 may store instructions that when executed by control circuitry 1011 run a virtual wallet application, to perform the functions described above with respect to the other figures of this disclosure. Server 1004 may also include an input/output path 1012. I/O path 1012 may provide interactivity data, device information, or other data, over a personal area network (PAN), local area network (LAN), or wide area network (WAN), and/or other content and data to control circuitry 1011, which may include processing circuitry, and storage 1014. In some embodiments, I/O path 1012 may include any suitable circuitry (e.g., control circuitry, processing circuitry, etc.). Control circuitry 1011 may be used to send and receive commands, requests, and other suitable data using I/O path 1012, which may comprise I/O circuitry. I/O path 1012 may connect control circuitry 1011 (and specifically control circuitry) to one or more communications paths.

In some embodiments, user equipment 900 and merchant point-of-sale device 901 may comprise device drivers, e.g., a video capture driver, an audio capture driver, or any other suitable driver, or any combination thereof, to interface with sensors of user equipment 900 and/or secondary devices 1001. For example, the video capture driver may comprise any suitable combination of hardware or software to interface with an image sensor (e.g., camera 918) configured to capture images of an environment surrounding user equipment 900 and merchant point-of-sale device 901. In some embodiments, the audio capture driver may comprise any suitable combination of hardware or software to interface with a microphone (e.g., microphone 916) configured to capture ambient audio of an environment surrounding user equipment 900 and merchant point-of-sale device 901. In some embodiments, the video capture driver may be configured to receive requests for image data (e.g., video and/or other imagery) from user equipment 900 and/or merchant point-of-sale device 901.

Control circuitry 1011 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1011 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1011 executes instructions for an emulation system application stored in memory (e.g., the storage 1014). Memory may be an electronic storage device provided as storage 1014 that is part of control circuitry 1011.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, via a user interface at a point-of-sale device, a biometric input corresponding to a transaction;
determining, based on the biometric input, a probability that a user initiated the transaction under duress;
in response to determining that the probability is less than a threshold probability level, approving the transaction; and
in response to determining that the probability is greater than or equal to the threshold probability level, initiating a supplemental action for the transaction.

2. The method of claim 1, wherein the supplemental action for the transaction comprises flagging the transaction for additional review.

3. The method of claim 1, wherein the supplemental action for the transaction comprises requesting authorization from a secondary device associated with the user, and wherein the method further comprises:
receiving the authorization from the secondary device; and
in response to receiving the authorization from the secondary device, approving the transaction.

4. The method of claim 1, wherein the supplemental action comprises capturing image data and audio data from one or more image sensors and audio sensors in proximity to the point-of-sale device after the biometric input was received.

5. The method of claim 1, wherein determining the probability that the user initiated the transaction under duress comprises determining the probability based on (a) the biometric input received via the user interface at the point-of-sale device and (b) a transaction history of the user.

6. The method of claim 1, further comprising:
determining the probability that the user initiated the transaction under duress based on secondary biometric data captured by a secondary device associated with the user.

7. The method of claim 6, wherein the secondary biometric data comprises raw data, the method further comprising:
receiving, by a point-of-sale system comprising the point-of-sale device, the raw data from the secondary device; and
determining, by the point-of-sale system, the probability that the user is initiating the transaction under duress based on the raw data.

8. The method of claim 6, further comprising:
receiving, by a point-of-sale system comprising the point-of-sale device from the secondary device, a first probability that the user initiated the transaction under duress, wherein the first probability is determined at the secondary device based on the secondary biometric data captured by the secondary device; and
selecting as the probability that the user initiated the transaction under duress, the first probability received from the secondary device.

9. The method of claim 6, further comprising:
receiving, from the secondary device, an indication of a threshold change in the secondary biometric data during a time period prior to the transaction; and
determining the probability that the user initiated the transaction under duress based on the threshold change in the secondary biometric data during the time period prior to the transaction.

10. The method of claim 1, further comprising:
after receiving the biometric input corresponding to the transaction, detecting a gesture input; and
selecting a payment method for the transaction based on the gesture input.

11. A system comprising:
input/output circuitry configured to:
receive, via a user interface at a point-of-sale device, a biometric input corresponding to a transaction; and
control circuitry configured to:
determine, based on the biometric input, a probability that a user initiated the transaction under duress;
in response to determining that the probability is less than a threshold probability level, approve the transaction; and
in response to determining that the probability is greater than or equal to the threshold probability level, initiate a supplemental action for the transaction.

12. The system of claim 11, wherein the supplemental action for the transaction comprises flagging the transaction for additional review.

13. The system of claim 11, wherein the supplemental action for the transaction comprises requesting authorization from a secondary device associated with the user,
wherein the input/output circuitry is further configured to receive the authorization from the secondary device, and
wherein the control circuitry is further configured to, in response to receiving the authorization from the secondary device, approve the transaction.

14. The system of claim 11, wherein the supplemental action comprises capturing image data and audio data from one or more image sensors and audio sensors in proximity to the point-of-sale device after the biometric input was received.

15. The system of claim 11, wherein the control circuitry is further configured to determine the probability that the user initiated the transaction under duress by determining the probability based on (a) the biometric input received via the user interface at the point-of-sale device and (b) a transaction history of the user.

16. The system of claim 11, wherein the control circuitry is further configured to:
determine the probability that the user initiated the transaction under duress based on secondary biometric data captured by a secondary device associated with the user.

17. The system of claim 16, wherein the secondary biometric data comprises raw data, and wherein:
the input/output circuitry is further configured to receive, by a point-of-sale system comprising the point-of-sale device, the raw data from the secondary device, and
the control circuitry is further configured to determine, by the point-of-sale system, the probability that the user is initiating the transaction under duress based on the raw data.

18. The system of claim 16, wherein:
the input/output circuitry is further configured to receive, by a point-of-sale system comprising the point-of-sale device from the secondary device, a first probability that the user initiated the transaction under duress, wherein the first probability is determined at the secondary device based on the secondary biometric data captured by the secondary device, and
the control circuitry is further configured to select as the probability that the user initiated the transaction under duress, the first probability received from the secondary device.

19. The system of claim 16, wherein:
the input/output circuitry is further configured to receive, from the secondary device, an indication of a threshold change in the secondary biometric data during a time period prior to the transaction, and
the control circuitry is further configured to determine the probability that the user initiated the transaction under duress based on the threshold change in the secondary biometric data during the time period prior to the transaction.

20. The system of claim 11, wherein the control circuitry is further configured to:
after receiving the biometric input corresponding to the transaction, detect a gesture input; and
select a payment method for the transaction based on the gesture input.

21-50. (canceled)
